(19) United States
(12) Patent Application Publication
(10) Pub. No.: US 2024/0159965 A1
(43) Pub. Date: May 16, 2024

(54) OPTICAL POLARIZATION CONVERTER

(71) Applicant: Lumentum Operations LLC, San Jose, CA (US)

(72) Inventor: John M. HEATON, Worcestershire (GB)

(21) Appl. No.: 18/169,566

(22) Filed: Feb. 15, 2023

Related U.S. Application Data
(60) Provisional application No. 63/383,571, filed on Nov. 14, 2022.

(51) Int. Cl. G02B 6/14; G02B 6/122

(52) U.S. Cl. CPC G02B 6/14; G02B 6/1228; G02B 2006/12095

(57) ABSTRACT

An optical polarization converter includes an optical waveguide. A portion of the optical waveguide has an asymmetric cross-section profile. For example, a cross-section of the portion of the optical waveguide may not have symmetry associated with a horizontal axis and may not have symmetry associated with a vertical axis. The portion of the optical waveguide is tapered. For example, the portion of the optical waveguide may be associated with one or more taper ratios. The portion of the optical waveguide is configured to convert a polarization mode of an optical beam from a first fundamental polarization mode to a second fundamental polarization mode, such as from a fundamental transverse electric (TE) polarization mode to a fundamental transverse magnetic (TM) polarization mode (or vice versa).

### CROSS-REFERENCE TO RELATED APPLICATION

This patent application claims priority to U.S. Provisional Patent Application No. 63/383,571, filed on Nov. 14, 2022, and entitled “FABRICATION TOLERANT WAVEGUIDE POLARIZATION CONVERTER.” The disclosure of the prior application is considered part of and is incorporated by reference into this patent application.

### TECHNICAL FIELD

The present disclosure relates generally to an optical polarization converter and to a polarization converter that includes an optical waveguide.

### BACKGROUND

Optical transceiver modules are used to transmit and receive optical signals for various high-bandwidth data communications applications. An optical transceiver module may include a transmitter optical sub-assembly (TOSA) for transmitting optical signals and a receiver optical sub-assembly (ROSA) for receiving optical signals.

### SUMMARY

In some implementations, an optical polarization converter includes an optical waveguide, wherein a portion of the optical waveguide has a cross-section that is asymmetric, with respect to a horizontal axis and a vertical axis, at a plurality of points along a length of the portion, and the portion of the optical waveguide is tapered along the length of the portion.

In some implementations, an optical polarization converter includes an optical waveguide, wherein a portion of the optical waveguide has an asymmetric, with respect to a horizontal axis and a vertical axis, cross-section profile, and the portion of the optical waveguide is tapered.

In some implementations, an optical polarization converter includes an optical waveguide, wherein a portion of the optical waveguide is asymmetric along a length of the portion, and the portion of the optical waveguide is tapered.

### BRIEF DESCRIPTION OF THE DRAWINGS

FIGS. 1A-1B are diagrams of an example implementation described herein.

FIG. 2 shows diagrams of an example implementation described herein.

FIGS. 3A-3D are diagrams showing an example propagation of an optical beam within an optical waveguide of an optical polarization converter described herein.

FIG. 4 shows a plot of polarization mode angles of an example optical beam at points along a length of a tapered, asymmetrical portion of an optical waveguide of an optical polarization converter described herein.

FIG. 5 shows a plot of polarization mode angles of an example optical beam at points along a length of a tapered, asymmetrical portion of an optical waveguide of an optical polarization converter described herein.

FIG. 6 shows a plot of normalized polarization mode output power of an example optical beam in relation to a taper length of a tapered, asymmetrical portion of an optical waveguide of an optical polarization converter described herein.

### DETAILED DESCRIPTION

The following detailed description of example implementations refers to the accompanying drawings. The same reference numbers in different drawings may identify the same or similar elements.

An optical transceiver module typically supports two different data transmission signals that are associated with two orthogonal polarization modes. In many cases, a TOSA of the optical transceiver module includes a photonic integrated circuit (“PIC”) that facilitates generation of two data transmission signals in a same fundamental polarization mode, such as a fundamental transverse electric (TE) polarization mode (e.g., that is associated with a horizontal axis of the PIC of the TOSA). One of the data transmission signals is then converted to an orthogonal fundamental polarization mode, such as a fundamental transverse magnetic (TM) polarization mode (e.g., that is associated with a vertical axis of the PIC of the TOSA), using one or more micro-optic components included in the TOSA. The one or more micro-optic components are typically separated from the PIC, which results in an increased size (e.g., footprint) of the TOSA and an increased complexity in the design, manufacture, and assembly of the TOSA (e.g., to accommodate and align the PIC and the one or more micro-optic components). Using an on-chip polarization converter instead of one or more micro-optic components is not practical, because such converters suffer from conversion reliability and yield issues due to fabrication tolerance challenges.

Some implementations described herein provide an optical polarization converter. The optical polarization converter includes an optical waveguide. A portion of the optical waveguide has an asymmetric cross-section (e.g., the portion of the optical waveguide is asymmetric with respect to a vertical axis and with respect to a horizontal axis). Additionally, the portion of the optical waveguide is tapered (e.g., along a length of the portion of the optical waveguide). Accordingly, the portion of the optical waveguide is configured to convert a polarization mode of an optical beam from a first fundamental polarization mode to a second fundamental polarization mode (e.g., from a fundamental TE polarization mode to a fundamental TM polarization mode, or vice versa). For example, the portion of the optical waveguide (e.g., due to the asymmetric cross-section and the tapering) may cause a polarization mode angle of the optical beam to rotate as the optical beam propagates from an input end of the portion of the optical waveguide to an output end of the portion of the optical waveguide, which enables conversion of the polarization mode of the optical beam from the first fundamental polarization mode to the second fundamental polarization mode.

In this way, the optical polarization converter enables conversion from the first fundamental polarization mode to the second fundamental polarization mode without in-between conversion to a higher order polarization mode. Accordingly, the optical polarization converter is less lossy and provides higher conversion efficiency than other types of polarization conversion approaches (e.g., that use micro-optic components and/or on-chip polarization converters). Further, the optical polarization converter enables aperiodic conversion from the first fundamental polarization mode to the second fundamental polarization mode (e.g., the conversion only occurs once, and does not convert back). This results in the optical polarization converter being insensitive to fabrication tolerance issues (e.g., because a length of the portion of the optical waveguide just needs to be sufficiently long to enable the aperiodic conversion), which increases a likelihood that the optical polarization converter can be used in practical applications (as opposed to typical on-chip polarization converters that suffer from fabrication tolerance issues).

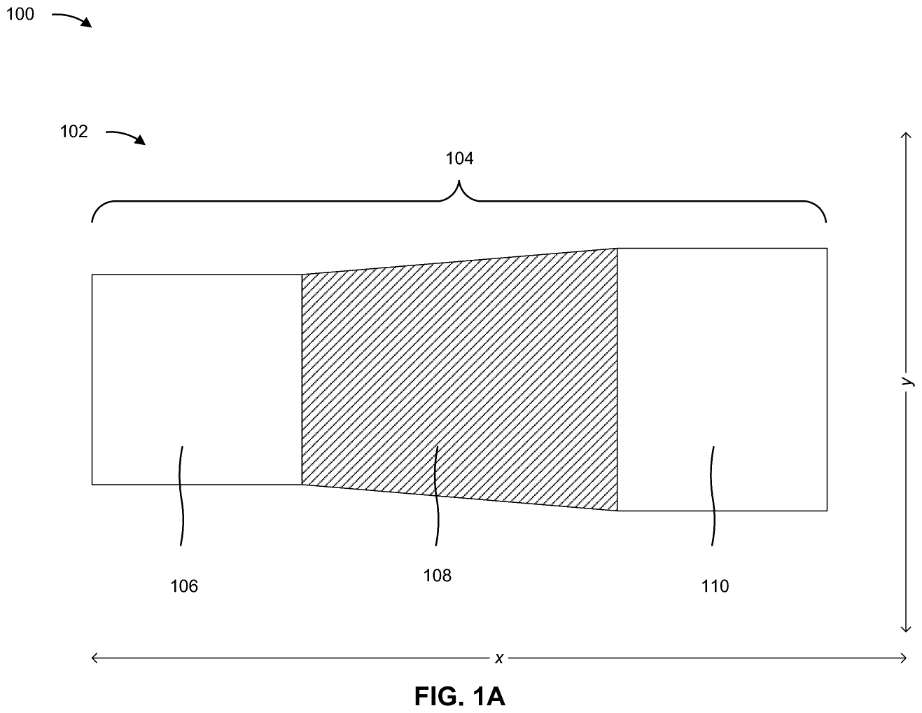

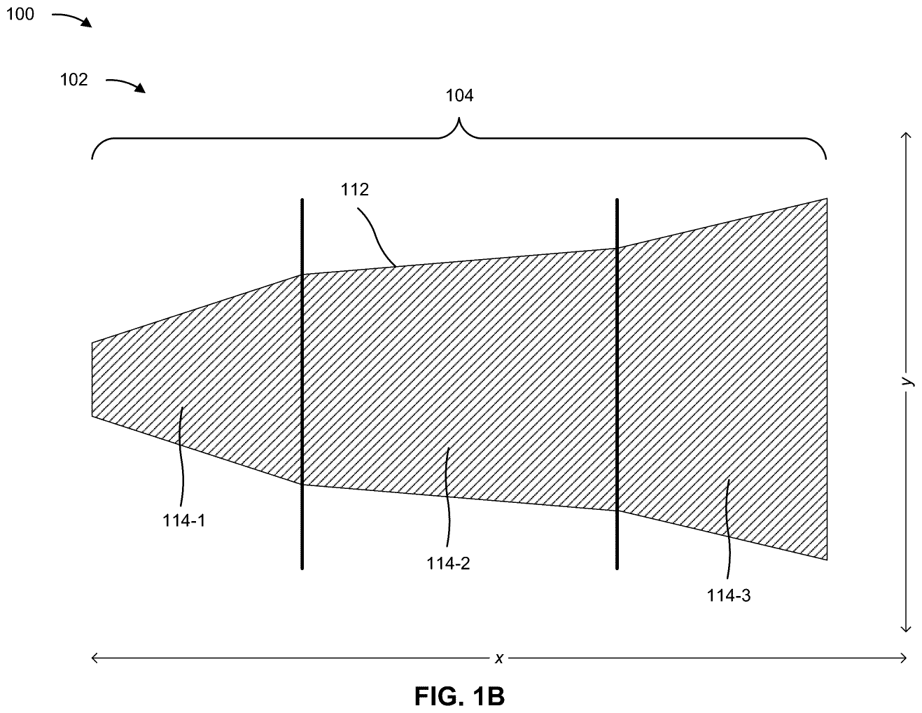

FIGS. 1A-1B are diagrams of an example implementation 100 described herein. As shown in FIGS. 1A-1B, example implementation 100 includes an optical polarization converter 102. The optical polarization converter 102 may be configured to convert a polarization mode of an optical beam (e.g., from a first fundamental polarization mode to a second fundamental polarization mode, as described herein). FIG. 1A shows a top-down view of a first configuration of the optical polarization converter 102, and FIG. 1B shows a top-down view of a second configuration of the optical polarization converter 102.

In some implementations, the optical polarization converter 102 may include an optical waveguide 104. The optical waveguide 104 may be a semiconductor optical waveguide. For example, the optical waveguide 104 may comprise at least one semiconductor material, such as a material that comprise indium phosphide (InP), silicon (Si), gallium arsenide (GaAs), or another semiconductor material. Alternatively, the optical waveguide 104 may be another type of optical waveguide, such as a glass optical waveguide.

The optical waveguide 104 may comprise one or more portions, such as portions 106, 108, and/or 110 shown in FIG. 1A, or portion 112 shown in FIG. 1B. In some implementations, the optical waveguide 104 may include the portion 108, and may optionally include portions 106 and/or 110. A portion of the optical waveguide 104 may be tapered. For example, as shown in FIG. 1A, the portion 108 may be tapered along a length of the portion 108, which may be parallel to the x axis shown in FIG. 1A. That is, a thickness (e.g., a diameter, breadth, or another thickness measurement along a width of the portion 108, which may be parallel to they axis shown in FIG. 1A) may be different at multiple points along the length of the portion 108. The portion 108 may be associated with a taper ratio, such that the portion 108 is tapered according to the taper ratio from a first end of the portion 108 to a second end of the portion 108 (or from the second end to the first end).

In some implementations, a tapered portion of the optical waveguide 104 may be associated with a plurality of taper ratios. For example, as shown in FIG. 1B, the portion 112 may include a plurality of sub-portions 114 (shown as sub-portions 114-1, 114-2, and 114-3) that are associated with respective taper ratios. At least some of the taper ratios of the sub-portions 114 may be different from each other (e.g., not equal to each other). For example, the sub-portion 114-1 may be tapered according to a first taper ratio, the sub-portion 114-2 may be tapered according to a second taper ratio (e.g., that is different from the first taper ratio), and the sub-portion 114-3 may be tapered according to a third taper ratio (e.g., that is different than the second taper ratio and/or the first taper ratio).

In some implementations, a portion of the optical waveguide 104 may not be tapered. For example, as shown in FIG. 1A, the portions 106 and 110 may not be tapered along their respective lengths (that may be parallel to the x axis shown in FIG. 1A). That is, a thickness of each portion of the portions 106 and 110 may be the same (e.g., equal to, within a tolerance, which may be less than or equal to a percentage, such as 10%, of a maximum thickness of the portion) at multiple points along the length of the portion. Put another way, the portion may not be associated with a taper ratio (e.g., the portion is not tapered according to a taper ratio).

Accordingly, the optical waveguide 104 may include a plurality of portions, where at least one portion is tapered, or at least one portion is tapered and at least one portion is not tapered, such as shown in FIG. 1A. Alternatively, the optical waveguide 104 may include a single tapered portion, such as shown in FIG. 1B.

As indicated above, FIGS. 1A-1B are provided as examples. Other examples may differ from what is described with regard to FIGS. 1A-1B.

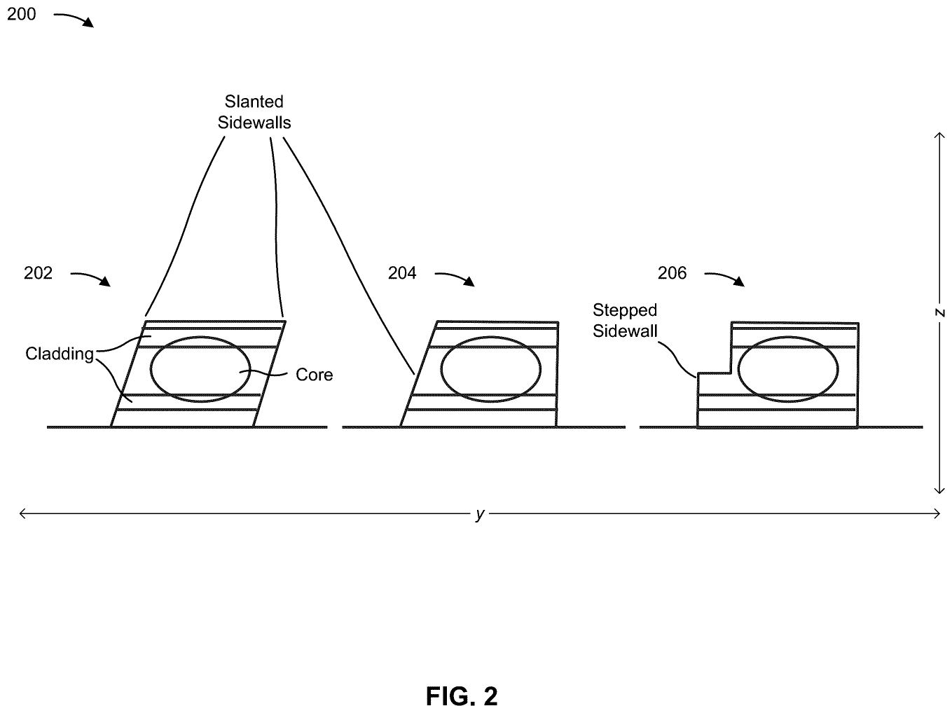

FIG. 2 shows diagrams of an example implementation 200 described herein. FIG. 2 shows example cross-sections of a portion of the optical waveguide 104 at a point along a length of the portion of the optical waveguide 104. As shown in FIG. 2, a cross-section of the portion of the optical waveguide 104 may be asymmetric. That is, the portion of the optical waveguide 104 may not have symmetry associated with multiple axes. For example, the portion of the optical waveguide 104 may not have symmetry associated with a first axis, such as a horizontal axis (e.g., they axis shown in FIG. 2), and may not have symmetry associated with a second axis, such as a vertical axis (e.g., the z axis shown in FIG. 2), that is orthogonal to the first axis. That is, the portion of the optical waveguide 104 may have horizontal asymmetry such that the portion of the optical waveguide 104 is asymmetric about a vertical mirror plane (e.g., that runs through the center of the portion of the optical waveguide 104), sometimes referred to as “left-right” asymmetry; and/or the portion of the optical waveguide 104 may have vertical asymmetry such that the portion of the optical waveguide 104 is asymmetric about a horizontal mirror plane (e.g., that runs through the center of the portion of the optical waveguide 104), sometimes referred to as “up-down” asymmetry.

For the cross-section of the portion of the optical waveguide 104 to be asymmetric (e.g., with respect to the horizontal axis and the vertical axis), the portion of the optical waveguide 104 may include one or more slanted sidewalls (e.g., as shown by reference numbers 202 and 204) that may be respectively associated with one or more slant angles, one or more stepped sidewalls (e.g., as shown by reference number 206), a core with a stepped thickness or a graded refractive index, and/or a cladding with a stepped thickness or graded refractive index, among other examples.

In some implementations, the portion of the optical waveguide 104 may be asymmetric at multiple points along the length of the portion of the optical waveguide 104. That is, the portion of the optical waveguide 104 may not have symmetry associated with multiple axes (e.g., with respect to the horizontal axis and the vertical axis) at each point of the multiple points along the length of the portion of the optical waveguide 104. For example, the portion of the optical waveguide 104 may have an asymmetric cross-section at each point.

In some implementations, the portion of the optical waveguide 104 may be curved and may be asymmetric along the length of the portion of the optical waveguide 104. For example, the portion of the optical waveguide 104 may be curved in association with a bend radius, and may not have symmetry associated with at least one axis (e.g., at least the vertical axis) along the length of the portion of the optical waveguide 104. Accordingly, the portion of the optical waveguide 104 may have one or more curved sidewalls that may be associated with a bend radius (e.g., that is aligned with a particular axis, such as the horizontal axis) and a cross-section of the portion of the optical waveguide 104 may be asymmetric along the length of the portion of the optical waveguide (e.g., with respect to the vertical axis). In some implementations, the asymmetry of the optical waveguide 104 may be caused by, in whole or in part (e.g., with respect to an asymmetric cross-section of the optical waveguide 104), a curvature of a path of the optical waveguide 104 (e.g., that is curved in association with the bend radius).

In some implementations, the portion of the optical waveguide 104 may be tapered (e.g., as described herein in relation to FIGS. 1A-1B), and may also be asymmetric (e.g., with respect to the horizontal axis and the vertical axis) or asymmetric (e.g., with respect to the vertical axis) and curved. For example, each portion of the portion 108 of the optical waveguide 104 shown in FIG. 1A and/or the portion 112 of the optical waveguide 104 shown in FIG. 1B, which are tapered, may be asymmetric (e.g., may be asymmetric at one or more points along the length of the portion with respect to the horizontal axis and the vertical axis) or may asymmetric (e.g., may be asymmetric at one or more points along the length of the portion with respect to the vertical axis) and curved (e.g., in association with a bend radius). Accordingly, the portion of the optical waveguide 104 may be configured to convert a polarization mode of an optical beam (e.g., from a first fundamental polarization mode to a second fundamental polarization mode) as the optical beam propagates from an input end of the portion of the optical waveguide 104 to an output end of the portion of the optical waveguide 104, as described herein.

In some implementations, another portion of the optical waveguide 104 may be symmetric (e.g., may have a cross-section that is symmetric at one or more points along a length of the other portion). For example, each portion of the portions 106 and 110 of the optical waveguide 104 shown in FIG. 1A may be symmetric, and therefore each portion may be symmetric and not tapered. Accordingly, each portion of the portions 106 and 110 may not be configured to convert a polarization mode of an optical beam (as compared to a tapered, asymmetric portion of the optical waveguide 104, as described herein).

As indicated above, FIG. 2 is provided as an example. Other examples may differ from what is described with regard to FIG. 2.

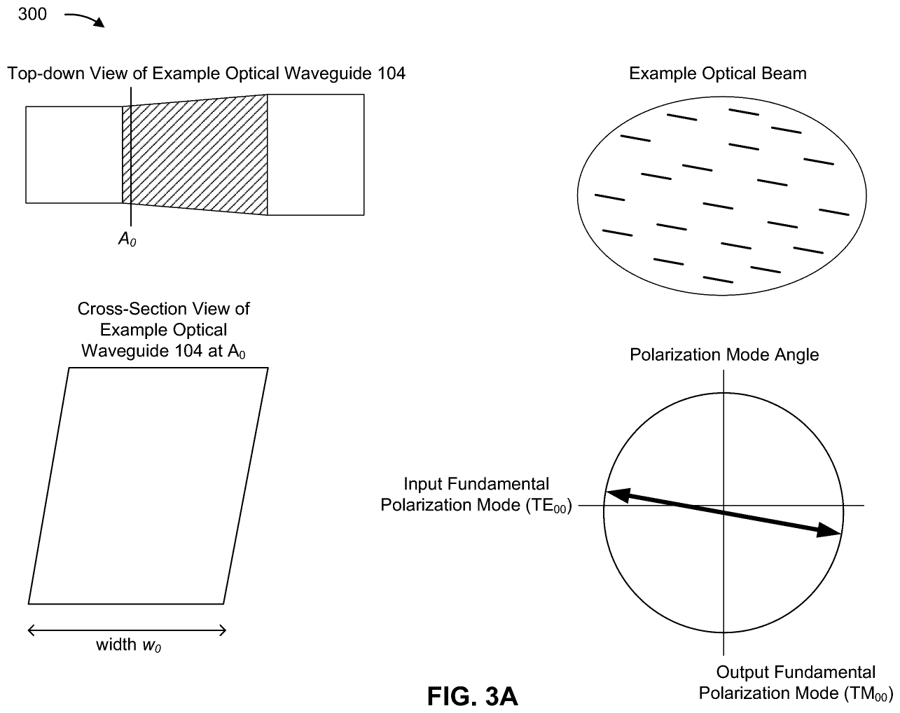

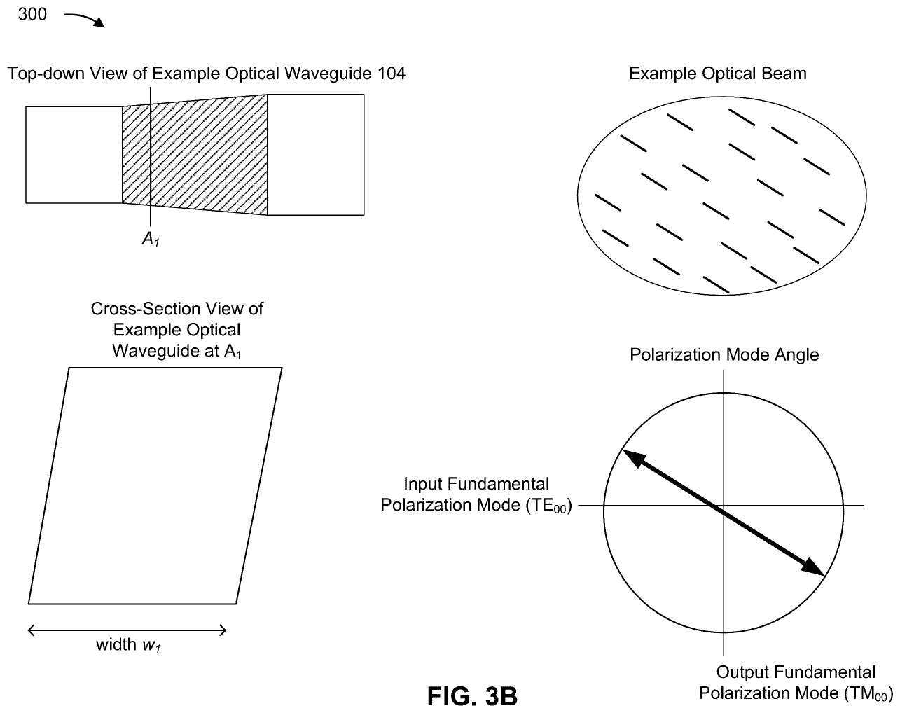

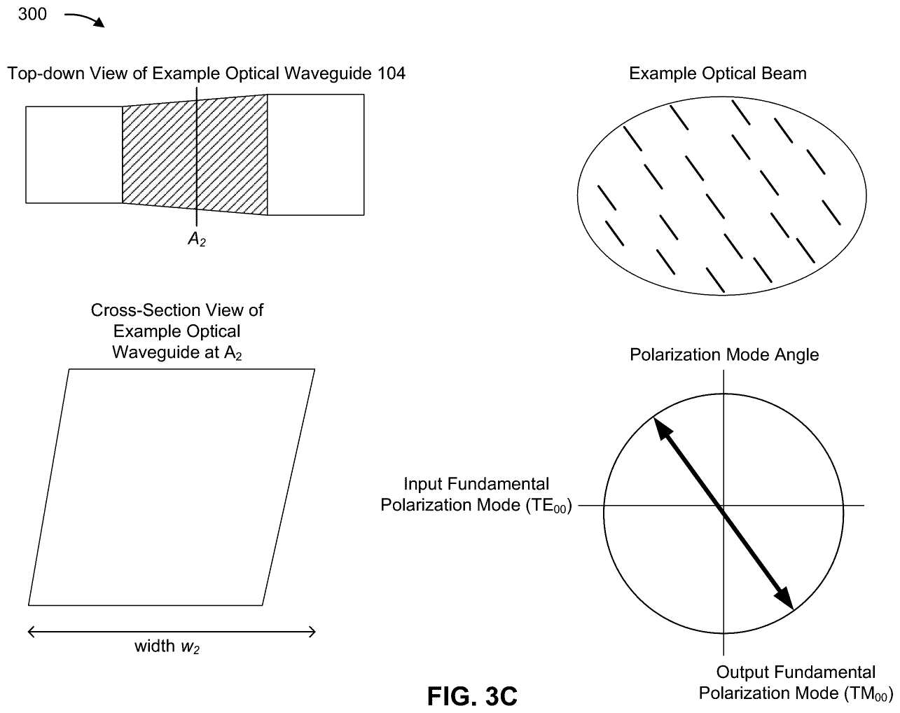

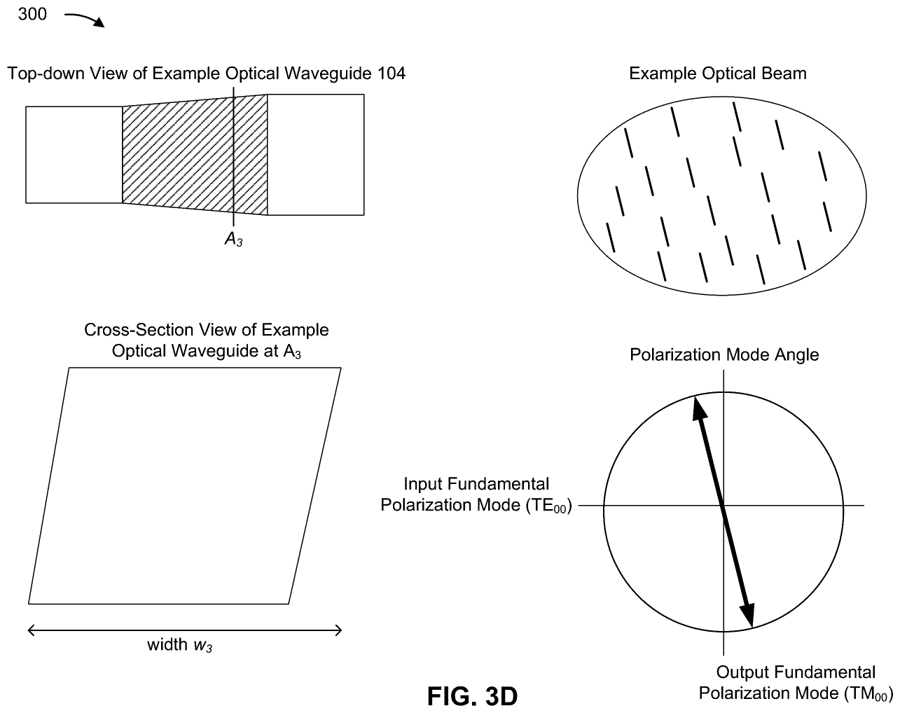

FIGS. 3A-3D are diagrams 300 showing an example propagation of an example optical beam from one end (e.g., an input end, shown as a left end) of a portion of an optical waveguide 104 (shown with diagonal patterning) of an optical polarization converter 102 to another end (e.g., an output end, shown as a right end) of the portion of the optical waveguide 104. As shown in FIGS. 3A-3D, the portion of the optical waveguide 104 may be a tapered and asymmetric (e.g., with respect to a horizontal axis and a vertical axis of the optical polarization converter 102 and/or the optical waveguide 104) portion, as described elsewhere herein. An optical beam may propagate from one end to another end of the portion of the optical waveguide 104 in a similar manner when the portion of the optical waveguide 104 is a tapered, asymmetric (e.g., with respect to the vertical axis), and curved (e.g., in associated with a bend radius) portion, as described elsewhere herein.

As shown in FIG. 3A, the optical waveguide 104 may have width w₀ at a point A₀ along a length of the portion of the optical waveguide 104. The point A₀ may be associated with the input end (e.g., the left end) of the portion of the optical waveguide 104. Accordingly, the example optical beam (shown with a plurality of “polarization vectors”) may have a polarization mode angle that is slightly rotated as compared to an angle (e.g., that is associated with horizontal axis, or 0 degrees, as shown in FIG. 3A) of an input fundamental polarization mode, such as a fundamental TE polarization mode (often termed “TE₀₀”). While the input fundamental polarization mode is shown as the fundamental TE polarization mode, implementations include a fundamental TM polarization mode (often termed “TM₀₀”) as the input fundamental polarization mode.

As shown in FIG. 3B, the optical waveguide 104 may have width w₁ (that is greater than the width w₀) at a point A₁ along the length of the portion of the optical waveguide 104. As further shown in FIG. 3B, because the portion of the optical waveguide 104 is tapered and asymmetric, the polarization mode angle of the example optical beam has rotated (e.g., away from the angle associated with the input fundamental polarization mode).

As shown in FIG. 3C, the optical waveguide 104 may have width w₂ (that is greater than each of the widths w₀ and w₁) at a point A₂ along the length of the portion of the optical waveguide 104. As further shown in FIG. 3C, because the portion of the optical waveguide 104 is tapered and asymmetric, the polarization mode angle of the example optical beam has rotated (e.g., further away from the angle associated with the input fundamental polarization mode).

As shown in FIG. 3D, the optical waveguide 104 may have width w₃ (that is greater than each of the widths w₀, w₁, and w₂) at a point A₃ along the length of the portion of the optical waveguide 104. As further shown in FIG. 3D, because the portion of the optical waveguide 104 is tapered and asymmetric, the polarization mode angle of the example optical beam has rotated. For example, the polarization mode angle may have rotated away from the angle associated with the input fundamental polarization mode toward an angle (e.g., that is associated with a vertical axis, or 90 degrees, as shown in FIG. 3D) that is associated with an output fundamental polarization mode, such as the fundamental TM polarization mode. While the output fundamental polarization mode is shown as the fundamental TM polarization mode, implementations include the fundamental TE polarization mode as the output fundamental polarization mode.

Accordingly, FIGS. 3A-3D show that the polarization mode of the example optical beam has converted from the input fundamental polarization mode to the output fundamental polarization mode. For example, if the input fundamental polarization mode is associated with the fundamental TE polarization mode, the output fundamental polarization mode may be associated with the fundamental TM polarization mode, or vice versa.

Further, FIGS. 3A-3D show that the portion of the optical waveguide 104 may be configured to rotate a polarization mode angle of an optical beam as the optical beam propagates from an input end of the portion of the optical waveguide 104 to an output end of the portion of the optical waveguide 104 (e.g., due to the portion of the optical waveguide 104 being tapered and asymmetric). Accordingly, the portion of the optical waveguide 104 may be configured to convert the polarization mode of the optical beam from a first fundamental polarization mode to a second fundamental polarization mode as the optical beam propagates from the input end of the portion of the optical waveguide to the output end of the portion of the optical waveguide. For example, when the first fundamental polarization mode is associated with a first axis (e.g., a horizontal axis, such as for TE₀₀, as shown in FIG. 3D) and the second fundamental polarization mode is associated with a second axis (e.g., a vertical axis, such as for TM₀₀, as shown in FIG. 3D), the portion of the portion of the optical waveguide 104 may be configured to rotate a polarization mode angle from being substantially aligned with the first axis (e.g., parallel to, within a threshold, which may be less than or equal to 0.5 degrees, 1 degree, 1.5 degrees, 2 degrees, 2.5 degrees, or 3 degrees) to being substantially aligned with the second axis (e.g., parallel to, within the threshold). Rotation of the polarization mode angle may ensure that the conversion from the first fundamental polarization mode to the second fundamental polarization mode is adiabatic (e.g., because the polarization mode of the optical beam passes through a continuous set of intermediate polarization modes).

While FIGS. 3A-3D show conversion of a polarization mode of an optical beam from a first fundamental polarization mode to a second fundamental polarization mode as the optical beam propagates from an input end to an output end of the portion of the optical waveguide 104, the portion of the optical waveguide 104 may be configured to convert a polarization mode of another optical beam from the second fundamental polarization mode to the first fundamental polarization mode as the other optical beam propagates from the input end of the portion of the optical waveguide to the output end of the portion of the optical waveguide. In this way, the portion of the optical waveguide 104 may be configured to convert polarization modes of multiple optical beams (e.g., simultaneously). For example, the portion of the optical waveguide 104 may be configured to simultaneously convert polarization modes of optical beams associated with different wavelengths (e.g., each optical beam is associated with a particular wavelength).

As indicated above, FIGS. 3A-3D are provided as examples. Other examples may differ from what is described with regard to FIGS. 3A-3D.

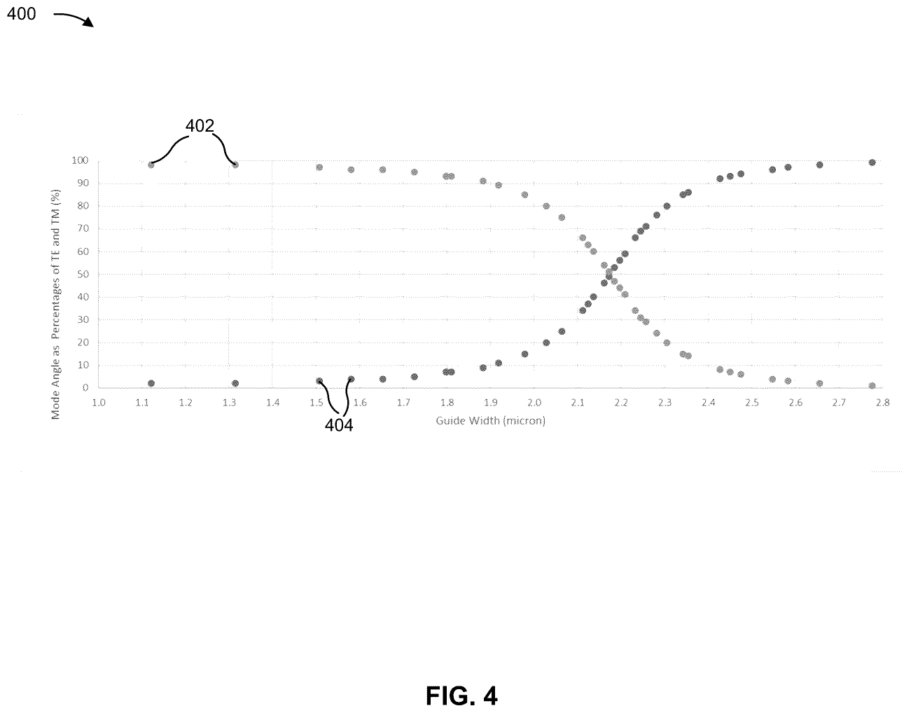

FIG. 4 shows a plot 400 of polarization mode angles (e.g., expressed as percentages of TE and TM polarizations modes) of an example optical beam at points along a length of a tapered, asymmetrical (e.g., with respect to a horizontal axis and a vertical axis) portion of an example optical waveguide 104 that are associated with particular widths. As shown in FIG. 4, a polarization mode of an optical beam (shown by reference dots 402 indicating TM polarization mode percentage and reference dots 404 indicating TE polarization mode percentage) may be converted from a fundamental TM polarization mode to a fundamental TE polarization mode as the optical beam propagates from a “thin” input end (e.g., with a width of 1.0 micrometers (μm)) of the portion of the optical waveguide 104 to a “thick” output end (e.g., with a width of 2.8 μm) of the portion of the optical waveguide 104. As further shown in FIG. 4, the conversion from the fundamental TM polarization mode to the fundamental TE polarization mode may be aperiodic, such that the conversion occurs only once (and does not convert back from the fundamental TE polarization mode to the fundamental TM polarization mode).

As indicated above, FIG. 4 is provided as an example. Other examples may differ from what is described with regard to FIG. 4.

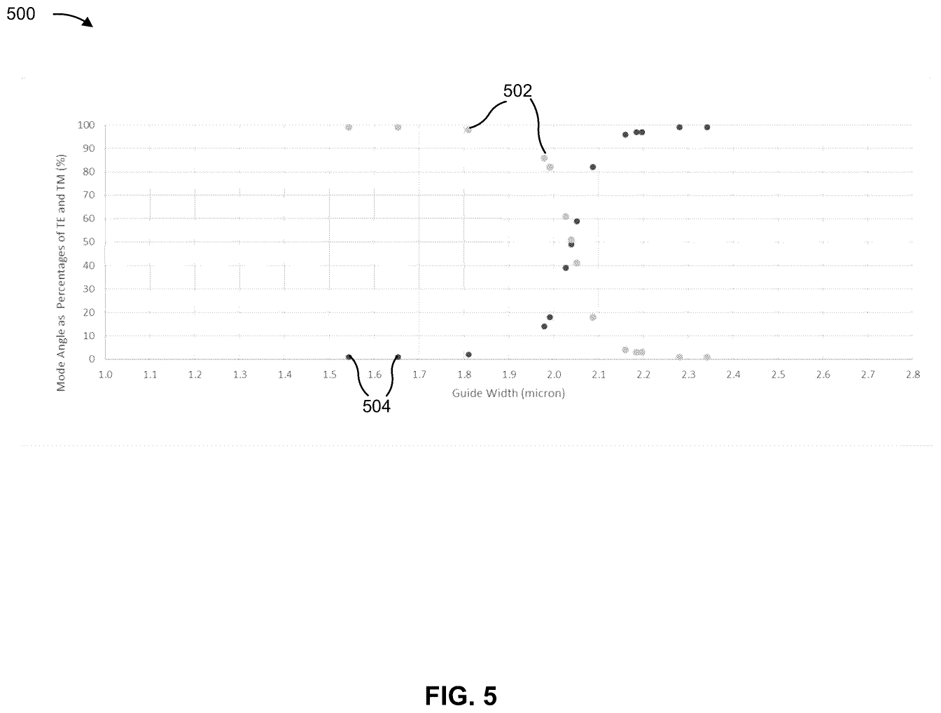

FIG. 5 shows a plot 500 of polarization mode angles (e.g., expressed as percentages of TE and TM polarizations modes) of an example optical beam at points along a length of a tapered, asymmetrical (e.g., with respect to a horizontal axis and a vertical axis) portion of an example optical waveguide 104 (e.g., that has sidewalls with slant angles that are less than slant angles of sidewalls of the portion of the example optical waveguide described herein in association with FIG. 4) that are associated with particular widths. As shown in FIG. 4, a polarization mode of an optical beam (shown by reference dots 502 indicating TM polarization mode percentage and reference dots 504 indicating TE polarization mode percentage) may be converted from a fundamental TM polarization mode to a fundamental TE polarization mode as the optical beam propagates from a “thin” input end (e.g., with a width of 1.5 μm) of the portion of the optical waveguide 104 to a “thick” output end (e.g., with a width of 2.4 μm) of the portion of the optical waveguide 104. As further shown in FIG. 5, the conversion from the fundamental TM polarization mode to the fundamental TE polarization mode may be aperiodic, such that the conversion occurs only once (and does not convert back from the fundamental TE polarization mode to the fundamental TM polarization mode).

As indicated above, FIG. 5 is provided as an example. Other examples may differ from what is described with regard to FIG. 5.

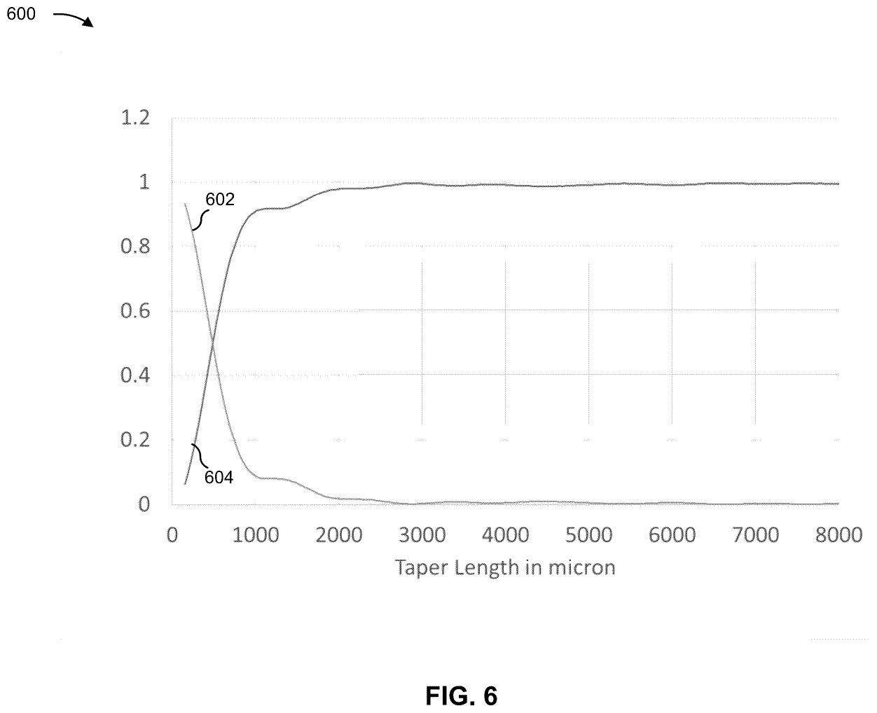

FIG. 6 shows a plot 600 of normalized polarization mode output power of an example optical beam in relation to a taper length of a tapered, asymmetrical portion of the optical waveguide 104. As shown in FIG. 6, and by reference line 602 that indicates a normalized TM polarization mode output power for a TE polarization mode input power, conversion from a fundamental TM polarization mode to a fundamental TE polarization mode may be independent of a length of the portion of the optical waveguide 104 (e.g., for lengths greater than 3000 μm). As further shown in FIG. 6, and by reference line 604 that indicates a normalized TE polarization mode output power for a TM polarization mode input power, conversion from a fundamental TE polarization mode to a fundamental TM polarization mode may be independent of a length of the portion of the optical waveguide 104 (e.g., for lengths greater than 3000 μm).

As indicated above, FIG. 6 is provided as an example. Other examples may differ from what is described with regard to FIG. 6.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical polarization converter, comprising:
an optical waveguide, wherein:
a portion of the optical waveguide has a cross-section that is asymmetric, with respect to a horizontal axis and a vertical axis, at a plurality of points along a length of the portion; and
the portion of the optical waveguide is tapered along the length of the portion.

2. The optical polarization converter of claim 1, wherein the portion of the optical waveguide includes at least one of:
one or more slanted sidewalls;
one or more stepped sidewalls;
one or more curved sidewalls;
a core with a stepped thickness or a graded refractive index; or
a cladding with a stepped thickness or a graded refractive index.

3. The optical polarization converter of claim 1, wherein the portion of the optical waveguide includes a plurality of sub-portions that are associated with respective taper ratios.

4. The optical polarization converter of claim 1, wherein the optical polarization converter is configured to convert a polarization mode of an optical beam from a first fundamental polarization mode to a second fundamental polarization mode.

5. The optical polarization converter of claim 1, wherein the portion of the optical waveguide is configured to convert a polarization mode of an optical beam from a first fundamental polarization mode to a second fundamental polarization mode as the optical beam propagates from an input end of the portion of the optical waveguide to an output end of the portion of the optical waveguide.

6. The optical polarization converter of claim 1, wherein the portion of the optical waveguide is configured to rotate a polarization mode angle of an optical beam as the optical beam propagates from an input end of the portion of the optical waveguide to an output end of the portion of the optical waveguide.

7. The optical polarization converter of claim 1, wherein at least one of:
another portion of the optical waveguide has a cross-section that is symmetric at one or more points along a length of the other portion; or
the other portion of the optical waveguide is not tapered along the length of the other portion.

8. An optical polarization converter, comprising:
an optical waveguide, wherein:
a portion of the optical waveguide has an asymmetric, with respect to a horizontal axis and a vertical axis, cross-section profile; and
the portion of the optical waveguide is tapered.

9. The optical polarization converter of claim 8, wherein the optical waveguide is a semiconductor optical waveguide.

10. The optical polarization converter of claim 8, wherein a cross-section of the portion of the optical waveguide does not have symmetry associated with the horizontal axis and does not have symmetry associated with the vertical axis.

11. The optical polarization converter of claim 8, wherein the portion of the optical waveguide is associated with a plurality of taper ratios.

12. The optical polarization converter of claim 8, wherein the portion of the optical waveguide is configured to convert a polarization mode of an optical beam from a first fundamental polarization mode to a second fundamental polarization mode.

13. The optical polarization converter of claim 12, wherein the first fundamental polarization mode is a fundamental transverse electric (TE) polarization mode and the second fundamental polarization mode is a fundamental transverse magnetic (TM) polarization mode.

14. The optical polarization converter of claim 12, wherein the first fundamental polarization mode is a fundamental transverse magnetic (TM) polarization mode and the second fundamental polarization mode is a fundamental transverse electric (TE) polarization mode.

15. An optical polarization converter, comprising:
an optical waveguide, wherein:
a portion of the optical waveguide is asymmetric along a length of the portion; and
the portion of the optical waveguide is tapered.

16. The optical polarization converter of claim 15, wherein the portion of the optical waveguide is asymmetric with respect to a horizontal axis and to a vertical axis of the optical waveguide.

17. The optical polarization converter of claim 15, wherein:
the portion of the optical waveguide is asymmetric with respect to a vertical axis of the optical waveguide; and
the portion of the optical waveguide is curved in association with a bend radius.

18. The optical polarization converter of claim 15, wherein the portion of the optical waveguide is associated with a plurality of taper ratios.

19. The optical polarization converter of claim 15, wherein the optical waveguide is configured to convert a polarization mode of an optical beam from a first fundamental polarization mode to a second fundamental polarization mode.

20. The optical polarization converter of claim 15, wherein the portion of the optical waveguide is configured to rotate a polarization mode angle of an optical beam as the optical beam propagates from an input end of the portion of the optical waveguide to an output end of the portion of the optical waveguide.
